(19) United States
(12) Patent Application Publication
(10) Pub. No.: US 2025/0334892 A1
(43) Pub. Date: Oct. 30, 2025

(54) FINE POWDER FOR TONER AND TONER

(71) Applicant: CANON KABUSHIKI KAISHA, Tokyo (JP)

(72) Inventors: Mari KABURAGI, Chiba (JP); Ichiro KANNO, Chiba (JP); Hayato IDA, Ibaraki (JP)

(21) Appl. No.: 19/191,422

(22) Filed: Apr. 28, 2025

(30) Foreign Application Priority Data
Apr. 30, 2024 (JP) 2024-073893
Mar. 19, 2025 (JP) 2025-044309

(51) Int. Cl. G03G 9/08; G03G 9/087

(52) U.S. Cl. CPC G03G 9/0825; G03G 9/0819; G03G 9/08773; G03G 9/08795

(57) ABSTRACT

Fine powder for toner and toner that can improve cleaning performance while reducing a decrease in the developability caused by contamination. The fine powder for toner includes a silicone oil. The isolated silicone oil satisfies that, based on the total number of silicon atoms, a percentage by number of a silicon atom having Q unit structure is 1% or more and 40% or less. A sum of a percentage by number of a silicon atom having D unit structure and a percentage by number of a silicon atom having M unit structure is 60% or more and 99% or less. The isolated silicone oil is contained in an amount of 0.1% by mass or more and 10.0% by mass or less.

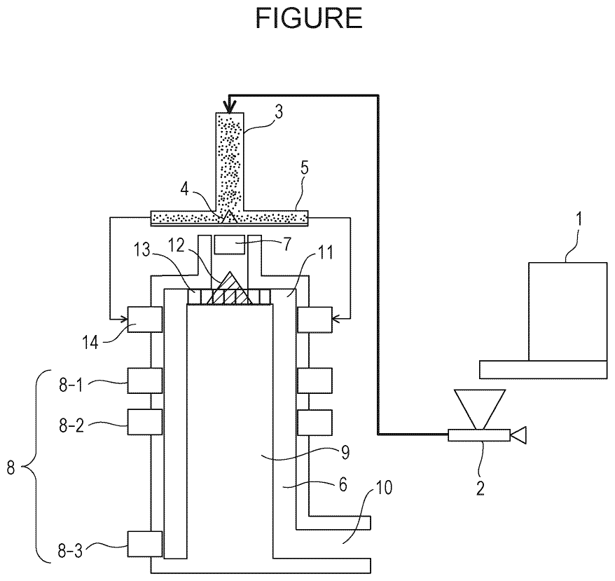

### BACKGROUND

### Technical Field

The present disclosure relates to fine powder for toner and toner including the fine powder for toner.

### Description of the Related Art

In recent years, as electrophotographic full-color copiers have become more widely used, there has been a demand for even higher image quality, and toner particles are getting smaller. However, as the toner particles become smaller, the toner is less likely to be scraped off by cleaning blades and more likely to slip past the cleaning blades during the cleaning process. This may cause so-called cleaning defects.

In a known method for improving cleaning performance, an inorganic particle treated with a silicone oil is used as an external additive such that the blocking layer (external additive blocking layer) formed of the external additive at a position near the cleaning blade nip is made stronger (Japanese Patent Laid-Open No. 2019-78779, and Japanese Patent Laid-Open No. 2016-57459). However, the silicone oil contaminates carriers and components, resulting in a decrease in the developability. In another known method, a resin fine particle internally containing silicone oil is contained in the toner (Japanese Patent Laid-Open No. 2017-58468). However, the resin fine particle is soft, and the silicone oil is exposed when the resin fine particle is crushed under stress in the developing unit. This also decrease the developability.

### SUMMARY

The present disclosure provides fine powder for toner and toner that are free from the above disadvantages. Specifically, the present disclosure provides fine powder for toner and toner that can improve cleaning performance while reducing a decrease in the developability caused by contamination.

The present disclosure provides fine powder for toner comprising a silicone oil, wherein the silicone oil isolated by an isolating method satisfies (i) and (ii) based on a total number of silicon atoms: (i) a percentage by number X1(%) of a silicon atom having a structure represented by formula (1) is 1% or more and 40% or less; and (ii) a sum of a percentage by number X2(%) of a silicon atom having a structure represented by formula (2) and a percentage by number X3(%) of a silicon atom having a structure represented by formula (3) is 60% or more and 99% or less, the isolated silicone oil is contained in an amount of 0.1% by mass or more and 10.0% by mass or less based on a mass of the fine powder. The isolating method includes: a) dispersing 10 g of the fine powder in 200 mL of hexane, followed by ultrasonication at a frequency of 30 kHz, a power output capacity of 15 W, and an intensity of 100% for 5 minutes; b) performing vacuum filtration on a dispersion obtained by the ultrasonication; and c) collecting filtrate and distilling off the hexane to isolate the silicone oil.

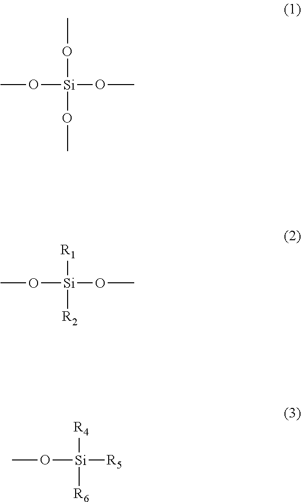

where R₁, R₂, and R₄ to R₆ each independently represent an alkyl group having 1 or more and 6 or less carbon atoms.

The present disclosure also provides toner comprising a toner particle and fine powder fixed or attached to a surface of the toner particle, wherein the fine powder is the above-described fine powder for toner.

Further features of the present disclosure will become apparent from the following description of exemplary embodiments with reference to the attached drawings.

### BRIEF DESCRIPTION OF THE DRAWING

FIGURE illustrates a heat treatment apparatus used in the present disclosure.

### DESCRIPTION OF THE EMBODIMENTS

In this disclosure, numerical ranges such as “XX or more and YY or less” or “XX to YY” include the minimum and maximum values at either end of the range unless otherwise specified.

### Process and Significance of Present Disclosure

The inventors presume that the effects of the present disclosure are demonstrated by the following mechanism. Conventionally, silicone oils used to improve the flowability and cleaning performance of external additives have generally been linear oils that have D and M units and have relatively low viscosity, such as a dimethyl silicone oil. When an external additive is treated with such a linear silicone oil, the additive blocking layer (hereinafter also referred to as “blocking layer”) is reinforced at the cleaning section because of free oil compared to the case without such treatment, but carriers and components are contaminated, resulting in a decrease in the developability.

In contrast, the silicone oil according to the present disclosure has a crosslinked structure having Q unit in addition to the D and M units. In the fine powder treated with the silicone oil having such a crosslinked structure, entanglement of molecular chains of the oil occurs when the particles of the powder are brought in contact with each other under pressure at the blocking layer portion, resulting in reinforcement of the blocking layer. In addition, the above oil is harder than the linear silicone oil. Thus, the oil is believed to less contaminate carriers and components, leading to the present disclosure.

### Fine Powder for Toner

Hereinafter, the configuration of the fine powder according to the present disclosure will be described in detail.

Fine powder for toner according to the present disclosure comprises a silicone oil, wherein the silicone oil isolated by an isolating method satisfies (i) and (ii) based on a total number of silicon atoms: (i) a percentage by number X1(%) of a silicon atom having a structure represented by formula (1) is 1% or more and 40% or less; and (ii) a sum of a percentage by number X2(%) of a silicon atom having a structure represented by formula (2) and a percentage by number X3(%) of a silicon atom having a structure represented by formula (3) is 60% or more and 99% or less, the isolated silicone oil is contained in an amount of 0.1% by mass or more and 10.0% by mass or less based on a mass of the fine powder. The isolating method includes: a) dispersing 10 g of the fine powder in 200 mL of hexane, followed by ultrasonication at a frequency of 30 kHz, a power output capacity of 15 W, and an intensity of 100% for 5 minutes; b) performing vacuum filtration on a dispersion obtained by the ultrasonication; and c) collecting filtrate and distilling off the hexane to isolate the silicone oil.

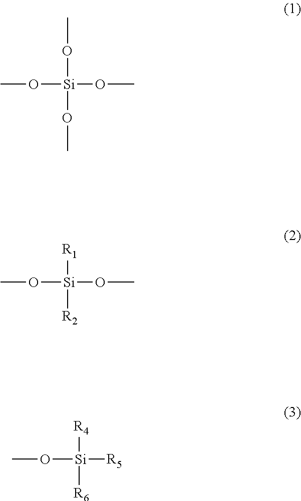

where R₁, R₂, and R₄ to R₆ each independently represent an alkyl group having 1 or more and 6 or less carbon atoms.

In the fine powder for toner according to the present disclosure, the silicone oil isolated by the above method satisfies that, based on the total number of silicon atoms, the percentage by number X1 of the silicon atom having the structure represented by formula (1) is 1% or more and 40% or less. When the percentage by number X1 is within the above range, the oil is moderately cross-linked and hardened, reducing contamination of carriers and components.

The percentage by number X1 is preferably 5% or more and 30% or less, more preferably 10% or more and 30% or less.

The silicone oil isolated by the above method satisfies that, based on the total number of silicon atoms, the sum of the percentage by number X2(%) of the silicon atom having the structure represented by formula (2) and the percentage by number X3(%) of the silicon atom having the structure represented by formula (3) is 60% or more and 99% or less. When the sum of the percentages by number of the silicon atoms represented by formulas (2) and (3) is within the above range, the compound is in the form of oil, enabling treatment of the fine powder.

The sum of the percentages by number of the silicon atoms (X2+X3) is preferably 70% or more and 95% or less, more preferably 75% or more and 90% or less.

The method for producing the silicone oil is not particularly limited. For example, the method includes adding a silane compound dropwise to water and subjecting the silane compound to hydrolysis and condensation reaction with a catalyst. The degree of crosslinking can be controlled, for example, by controlling the type of catalyst, pH, blending ratio of the silane compound, reaction temperature, and reaction time. Examples of the catalysts include, but are not limited to, acidic catalysts, such as hydrochloric acid, hydrofluoric acid, sulfuric acid, and nitric acid, and basic catalysts, such as ammonia water, sodium hydroxide, and potassium hydroxide. Details will be described below.

In the fine powder for toner according to the present disclosure, the silicone oil is contained in the amount of 0.1% by mass or more and 10.0% by mass or less based on a mass of the fine powder for toner. When the silicone oil content is within the above range, the silicone oil reinforces the blocking layer and improves the cleaning performance. The silicone oil content is preferably 0.5% by mass or more and 5.0% by mass or less, more preferably 1.0% by mass or more and 5.0% by mass or less.

The isolated silicone oil may satisfy:

$$1. 0 \leq X 2 / X 1 \leq 20.0 .$$

When X2/X1 is within the above range, the silicone oil is moderately cross-linked. Thus, from the above perspective, X2/X1, which can improve the cleaning performance and also prevent contamination, is more preferably 1.5 or more and 7.0 or less.

The isolated silicone oil may have a number-average molecular weight of 300 or more and 3000 or less. When the molecular weight is within the above range, entanglement of the molecular chains of the silicone oil readily occurs, reinforcing the blocking layer and improving the cleaning performance. From the above perspective, the molecular weight is more preferably 500 or more and 1500 or less.

The isolated silicone oil may have a kinematic viscosity of 100 mm²/s or more and 10000 mm²/s or less. When the kinematic viscosity is within the above range, the blocking layer is reinforced, and contamination of a component can be reduced. From the above viewpoint, the kinematic viscosity is more preferably 500 mm²/s or more and 5000 mm²/s or less.

The kinematic viscosity of the silicone oil can be controlled by controlling the blending ratio of silane compounds, reaction temperature, reaction time, and pH. The kinematic viscosity can be increased, for example, by increasing the percentage of a tetrafunctional or trifunctional silane monomer, increasing the reaction temperature, or increasing the reaction time. The kinematic viscosity can be decreased, for example, by increasing the percentage of a bifunctional silane monomer, decreasing the reaction temperature, and decreasing the reaction time.

A particle obtained by drying a residue left after the filtration (fine particle after removal of the silicone oil) in the isolating method may be an organosilicon polymer particle having one of structures represented by formulas (1), (2), (3), and (4),

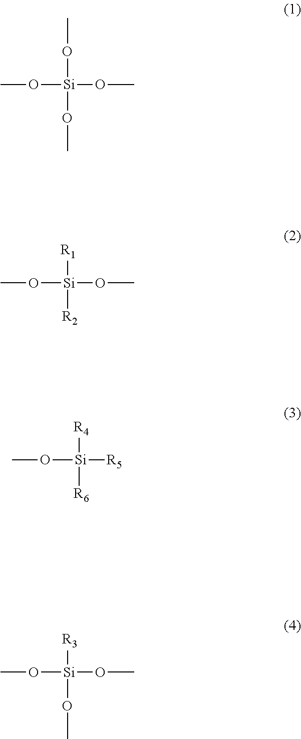

where R₁ to R₆ each independently represent an alkyl group having 1 or more and 6 or less carbon atoms. The organosilicon polymer particle, which has a similar structure to the silicone oil, has higher adhesion to the silicone oil, reliably reducing contamination.

Furthermore, the particle obtained by drying the residue may satisfy:

$$0 \leq ( Y 2 / Y 1 ) / ( X 2 / X 1 ) \leq 3. ,$$

where Y1(%) is a percentage by number of a silicon atom having the structure represented by formula (1), and Y2(%) is a percentage by number of a silicon atom having the structure represented by formula (2), based on a total number of silicon atoms in the particle obtained by drying the residue.

When (Y2/Y1)/(X2/X1) is within the above range, the silicone oil has a similar structure to the fine powder, increasing adhesion to the oil and reducing contamination. More preferably, (Y2/Y1)/(X2/X1) is within a range of 0.3 to 0.7.

The method for producing the organosilicon polymer particle is not particularly limited. For example, the method includes adding a silane compound dropwise to water, subjecting the silane compound to hydrolysis and condensation reaction with a catalyst, followed by filtration and drying of the resulting suspension. The particle diameter can be controlled by controlling the type of catalyst, blending ratio, temperature at the start of reaction, and drop time. Examples of the catalysts include, but are not limited to, acidic catalysts, such as hydrochloric acid, hydrofluoric acid, sulfuric acid, and nitric acid, and basic catalysts, such as ammonia water, sodium hydroxide, and potassium hydroxide. Details will be described below.

A particle obtained by drying a residue left after the filtration in the isolating method may have pores. Furthermore, the pores may have a volume-average diameter of 5 nm or more and 20 nm or less, and the pores may have an average volume of 0.3 cm³/g or more and 1.0 cm³/g or less. The fine powder having pores within the above range can retain silicone oil not only on the surface but also inside. When the fine powder contains the oil in it, the oil seeps when pressure is applied to the powder in the cleaning process and reinforces the blocking layer. In contrast, when pressure is not applied to the powder, the oil is retained inside the powder, and thus contamination is reduced. From the above perspective, the volume-average diameter of the pores is more preferably 10 nm or more and 20 nm or less, and the average volume is more preferably 0.3 cm³/g or more and 0.6 cm³/g or less.

In a wet production method, the average diameter and volume of the pores can be controlled by controlling the conditions of hydrolysis and condensation during reaction (reaction temperature, reaction time, and stirring time), pH, and type of catalyst, and further the ratio of added monomer. The pore diameter can be increased, for example, by increasing the mixing ratio of bifunctional silane, decreasing the temperature during the condensation reaction, decreasing the stirring time, decreasing the pH of the solution, or decreasing the temperature during hydrolysis. The pore diameter can be increased, for example, by increasing the mixing ratio of tetrafunctional silane, increasing the temperature during the condensation reaction, increasing the stirring time, increasing the pH of the solution, or increasing the temperature during hydrolysis. The pore volume can be increased, for example, by increasing the mixing ratio of bifunctional silane, decreasing the temperature during the condensation reaction, decreasing the stirring time, decreasing the pH of the solution, and decreasing the temperature during hydrolysis. The pore volume can be increased, for example, by increasing the mixing ratio of tetrafunctional silane, increasing the temperature during the condensation reaction, increasing the stirring time, increasing the pH of the solution, or increasing the temperature during hydrolysis.

The fine powder for toner may have a number-average diameter of 80 nm or more and 150 nm or less. The fine powder having the number-average diameter within the above range is less likely to slip past the cleaning blades and can form a blocking layer. From the above perspective, the number-average particle diameter is more preferably 90 nm or more and 130 nm or less.

In the fine powder for toner according to the present disclosure, a particle obtained by drying a residue left after the filtration in the isolating method may be a composite fine particle. The composite fine particle may have a base particle formed of an organosilicon polymer having one of the structures represented by formulas (1), (2), (3), and (4) and a protruding particle partially embedded in a surface of the base particle. When the fine powder has the above-described protruding portions, the protruding portions fit with each other in the blocking layer, making the blocking layer stronger. As the particle forming the protruding portions, any particle can be selected, but a silica fine particle can be particularly selected. The method for combining the protruding particle to the base particle formed of an organosilicon polymer will be described below.

The fine powder for toner may have a compression and agglomeration degree at 60 kPa of 100 mJ or more. The fine powder having the compression and agglomeration degree within the above range has sufficient agglomeration when pressure is applied at the cleaning section and thus can form a strong blocking layer. From the above perspective, the compression and agglomeration degree is more preferably 110 mJ or more.

### Method for Producing Silicone Oil

Although the method for producing the silicone oil is not particularly limited, the silicone oil can be synthesized through hydrolysis and condensation polymerization reaction of silicon compounds (silane monomers) in an aqueous system. Specifically, a mixture of bifunctional silane having two siloxane bonds and tetrafunctional silane having four siloxane bonds can be hydrolyzed and condensation polymerized with a catalyst. Silane monomers, such as bifunctional silane and tetrafunctional silane, will be described below. The degree of crosslinking and the molecular weight can be controlled, for example, by controlling the type of catalyst, blending ratio, reaction temperature, and reaction time. Examples of the catalysts include, but are not limited to, acidic catalysts, such as hydrochloric acid, hydrofluoric acid, sulfuric acid, and nitric acid, and basic catalysts, such as ammonia water, sodium hydroxide, and potassium hydroxide. The amount of the catalyst used may be adjusted depending on the type of silicon compound and catalyst. The reaction temperature is not particularly limited, and a temperature within the range of 5 to 70° C. can be selected in view of productivity and other factors.

The monomer used can be selected in view of, for example, compatibility with the solvent and catalyst, or hydrolyzability. Examples of tetrafunctional silane monomers having the above structure (1) include tetramethoxysilane, tetraethoxysilane, and tetraisocyanate silane. Among them, tetraethoxysilane can be particularly selected.

Examples of bifunctional silane monomers having the above structure (2) include di-tert-butyl dichlorosilane, di-tert-butyl dimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and dimethoxydiethylsilane. Among them, dimethoxydimethylsilane can be particularly selected.

Examples of monofunctional silane monomers forming the structure represented by formula (3) include t-butyldimethylchlorosilane, t-butyldimethylmethoxysilane, t-butyldimethylethoxysilane, t-butyldiphenylchlorosilane, t-butyldiphenylmethoxysilane, t-butyldiphenylethoxysilane, chlorodimethylphenylsilane, methoxydimethylphenylsilane, ethoxydimethylphenylsilane, chlorotrimethylsilane, methoxytrimethylsilane, ethoxytrimethylsilane, triethylmethoxysilane, triethylethoxysilane, tripropylmethoxysilane, tributylmethoxysilane, tripentylmethoxysilane, triphenylchlorosilane, triphenylmethoxysilane, and triphenylethoxysilane.

Examples of trifunctional silane monomers having the above structure (4) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxihydroxysilane, methyethoxymethoxihydrosilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane. Among them, methyltrimethoxysilane can be particularly selected.

### Method for Producing Composite Fine Particle of Organosilicon Polymer

Although the method for producing the composite fine particle of organosilicon polymer is not particularly limited, the particle can be formed through hydrolysis and condensation polymerization reaction of silicon compounds (silane monomers) by the sol-gel method. Specifically, the composite fine particle of the organosilicon polymer can be formed by reacting colloidal silica or the like through hydrolysis and condensation polymerization reaction of a mixture of bifunctional silane having two siloxane bonds and tetrafunctional silane having four siloxane bonds. Silane monomers, such as bifunctional silane and tetrafunctional silane, will be described below. The percentage of the bifunctional silane is preferably 30% by mole or more and 70% by mole or less, more preferably 40% by mole or more and 60% by mole or less.

The percentage of the tetrafunctional silane is preferably 30% by mole or more and 80% by mole or less, more preferably 40% by mole or more and 70% by mole or less.

The method for producing the organosilicon polymer is not particularly limited. For example, the method includes adding a silane compound dropwise to water, subjecting the silane compound to hydrolysis and condensation reaction with a catalyst, followed by filtration and drying of the resulting suspension. The particle diameter can be controlled by controlling the type of catalyst, blending ratio, temperature at the start of reaction, and drop time. Examples of the catalysts include, but are not limited to, acidic catalysts, such as hydrochloric acid, hydrofluoric acid, sulfuric acid, and nitric acid, and basic catalysts, such as ammonia water, sodium hydroxide, and potassium hydroxide.

The organosilicon polymer can be produced by the following method. Specifically, the method includes: a first step of obtaining a hydrolysate of a silicon compound; a second step of mixing the hydrolysate, an alkaline aqueous medium, and colloidal silica together and subjecting the hydrolysate to polycondensation reaction to react with the colloidal silica; and a third step of mixing the polycondensation reactant with an aqueous solution to form particles. In some cases, a hydrophobic agent such as hexamethyldisilazane may be further added.

In the first step, in an aqueous solution in which an acidic or alkaline substance that serves as a catalyst is dissolved in water, the silicon compound and the catalyst are brought into contact with each other by stirring, mixing, or other methods. Known catalysts can be suitably used as the catalyst. Specific examples of the catalysts include acidic catalysts, such as acetic acid, hydrochloric acid, hydrofluoric acid, sulfuric acid, and nitric acid and basic catalysts, such as ammonia water, sodium hydroxide, and potassium hydroxide.

The amount of the catalyst used may be adjusted depending on the type of silicon compound and catalyst. The amount of the catalyst is preferably within the range of 1×10⁻³ parts by mass or more to 1 part by mass or less relative to 100 parts by mass of water used for hydrolysis of the silicon compounds. When the amount of the catalyst used is 1×10⁻³ parts by mass or more, the reaction proceeds sufficiently. In contrast, when the amount of the catalyst used is 1 part by mass or less, the concentration of the catalyst remaining as impurities in the fine particles is low, resulting in easier hydrolysis. The amount of water used is preferably 2 mol or more and 15 mol or less relative to 1 mol of the silicon compound. When the amount of water used is 2 mol or more, the hydrolysis reaction proceeds sufficiently, and when the amount is 15 mol or less, productivity is improved.

The reaction temperature is not particularly limited, and the reaction may be carried out at room temperature or in a heated state. However, the reaction can be performed with the temperature being kept within a range of 10 to 60° C. because the hydrolysate can be produced in a short time and the partial condensation reaction of the generated hydrolysate can be reduced. The reaction time is not particularly limited and may be selected appropriately in view of the reactivity of the silicon compound used, the composition of the reaction solution of silicon compound, acid, and water, and the productivity.

In the method for producing the silicon polymer fine particle, the second step includes mixing the raw material solution obtained in the above-described first step with an alkaline aqueous medium and subjecting the particle precursor to polymerization condensation reaction. The polycondensation reaction solution is thus produced. Here, the alkaline aqueous medium is a liquid produced by mixing an alkaline component, water, and, if necessary, an organic solvent or other solvent.

The alkaline component used in the alkaline aqueous medium is one whose aqueous solution shows basicity, and the alkali component acts as a neutralizing agent for the catalyst used in the first step and as the catalyst for the polycondensation reaction in the second step. Examples of such alkali components include alkali metal hydroxides, such as lithium hydroxide, sodium hydroxide, and potassium hydroxide, ammonia, and organic amines, such as monomethylamine and dimethylamine.

The alkali component is used in a sufficient amount to neutralize the acid and act effectively as the catalyst for the polycondensation reaction. For example, when ammonia is used as the alkali component, the amount is usually 0.01 parts by mass or more and 12.5 parts by mass or less relative to 100 parts by mass of the mixture of water and an organic solvent.

In the second step, in addition to the alkali component and water, an organic solvent may be used to prepare the alkaline aqueous medium. Organic solvents are not particularly limited as long as they are compatible with water. In particular, organic solvents that dissolve at least 10 g of water per 100 g at room temperature and under normal pressure can be selected.

Specific examples of such organic solvents include alcohols, such as methanol, ethanol, n-propanol, 2-propanol, butanol, polyhydric alcohols, such as ethylene glycol, diethylene glycol, propylene glycol, glycerin, trimethylolpropane, and hexane triol, ethers, such as ethylene glycol monoethyl ether, acetone, diethyl ether, tetrahydrofuran, and diacetone alcohol, amide compounds, such as dimethylformamide, dimethylacetamide, and N-methylpyrrolidone.

Among the organic solvents listed above, alcohol solvents such as methanol, ethanol, 2-propanol, and butanol can be particularly selected. Furthermore, from the viewpoint of hydrolysis and dehydration-condensation reactions, an alcohol identical to the desorbed alcohol can be more particularly selected as the organic solvent.

In the second step, by mixing colloidal silica, a composite fine particle having a base particle formed of an organosilicon polymer and a protruding particle partially embedded in a surface of the base particle. The multiple protruding particles on the surface of the organosilicon polymer reinforce the blocking layer as the protruding portions derived from the protruding particles of the composite fine particles interlock with each other. The presence of the protruding portions derived from the protruding particles on the surface of the organosilicon polymer can be confirmed by observing the composite fine particles with scanning electron microscopy (SEM).

In the third step, the polycondensation reactant obtained in the second step is mixed with an aqueous solution to form particles. Water (e.g., tap water and pure water) can be suitably used as an aqueous solution. Furthermore, an additional component that is compatible with water, such as salts, acids, alkalis, organic solvents, surfactants, and water-soluble polymers, can be added to water. The temperature of the polycondensation reaction solution and aqueous solution at the mixing step is not particularly limited, and the temperature within a range of 5 to 70° C. is suitably selected in view of the composition, productivity, and other factors.

Any known method may be used as the method for collecting particles, without any particular limitations. For example, the floating powder may be skimmed off, or a filtration method may be employed, but a filtration method is particularly used because of its simple operation. The method of filtration is not particularly limited and may be a known method, such as vacuum filtration, centrifugal filtration, pressure filtration, or the like using a known apparatus. The filter paper, filter cloth or the like used in filtration is not particularly limited as long as it is industrially available and may be selected depending on the apparatus used.

The monomer used can be selected according to, for example, compatibility with the solvent and catalyst, or hydrolyzability. The monomers exemplified as monomers of the silicone oil can be also used.

Method for Treating Base Particle with Silicone Oil

The method for treating the base particle of the fine powder for toner with a silicone oil is not particularly limited. The base particle and the silicone oil may be separately produced, and then a wet or dry process may be performed. When a wet process is employed, a silane monomer as a raw material of the silicone oil and a catalyst may be added to a dispersion liquid of the base particle before filtration, followed by stirring. This allows the synthesis of the silicone oil and the surface treatment to be done at the same time. In addition to the silicone oil, another surface treatment agent, such as hexamethyldisilazane, may be used in combination.

### Toner Particle

Next, the composition of the toner particle to which the fine powder for toner according to the present disclosure is externally added will be described.

### Binder Resin

The binder resin used for toner is not particularly limited, and the following polymers and resins can be used as the binder resin.

Examples of the polymers and resins include homopolymers of styrene and substituted styrene compounds, such as polystyrene, poly-p-chlorostyrene, and poly(vinyl toluene), styrene-based copolymers, such as styrene-p-chlorostyrene copolymers, styrene-vinyl toluene copolymers, styrene-vinyl naphthalene copolymers, styrene-acrylic acid ester copolymers, styrene-methacrylic acid ester copolymers, styrene-α-chloromethyl methacrylate copolymers, styrene-acrylonitrile copolymers, styrene-vinyl methyl ether copolymers, styrene-vinyl ethyl ether copolymers, styrene-vinyl methyl ketone copolymers, and styrene-acrylonitrile-indene copolymers, poly(vinyl chloride) resins, phenolic resins, natural resin-modified phenolic resins, natural resin-modified maleic acid resins, acrylic resins, methacrylic resins, poly(vinyl acetate), silicone resins, polyester resins, polyurethane, polyamide resins, furan resins, epoxy resins, xylene resins, poly(vinyl butyral), terpene resins, cumarone-indene resins, and petroleum-based resins. Among them, polyester resins can be particularly selected from the perspective of stability of durability and charge stability. The acid value of the polyester resin is preferably 0.5 mgKOH/g or more and 40 mgKOH/g or less from the perspective of environmental stability and charge stability. The acid group of the polyester resin interacts with the Si—CH₃ in the fine powder, resulting in a further improvement in the toner chargeability under high humidity environments. The acid value is more preferably 1 mg KOH/g or more and 20 mg KOH/g or less, and even more preferably 1 mg KOH/g or more and 15 mg KOH/g or less.

### Colorant

The toner may contain a colorant as needed. Examples of the colorant include those listed below.

Examples of black colorants include carbon black and materials that are colored black through use of a yellow colorant, a magenta colorant, and a cyan colorant. The colorant may be a single pigment. However, a colorant including a combination of a dye and a pigment, which can improve the distinctness, can be employed from the perspective of full color image quality.

Examples of pigments for magenta toner include those listed below: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, and 282, C.I. Pigment Violet 19, and C.I. Vat Red 1, 2, 10, 13, 15, 23, 29, and 35.

Examples of dyes for magenta toner include those listed below: C.I. Solvent Red 1, 3, 8, 23, 24, 25, 27, 30, 49, 81, 82, 83, 84, 100, 109, and 121, C.I. Disperse Red 9, C.I. Solvent Violet 8, 13, 14, 21, and 27, oil soluble dyes such as C.I. Disperse Violet 1, C. I. Basic Red 1, 2, 9, 12, 13, 14, 15, 17, 18, 22, 23, 24, 27, 29, 32, 34, 35, 36, 37, 38, 39, and 40, basic dyes such as C.I. Basic Violet 1, 3, 7, 10, 14, 15, 21, 25, 26, 27, and 28.

Examples of pigments for cyan toner include those listed below: C.I. Pigment Blue 2, 3, 15:2, 15:3, 15:4, 16, and 17, C.I. Vat Blue 6, C.I. Acid Blue 45, and copper phthalocyanine pigments in which 1 to 5 phthalimidomethyl groups in the phthalocyanine skeleton are substituted.

An example of a dye for cyan toner is C. I. Solvent Blue 70.

Examples of pigments for yellow toner include those listed below: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, and 185, and C. I. Vat Yellow 1, 3, and 20.

An example of a dye for yellow toner is C. I. Solvent Yellow 162.

The colorant content is preferably 0.1 parts by mass or more and 30 parts by mass or less relative to 100 parts by mass of the binder resin.

### Wax

The toner may contain wax as needed. Examples of the wax include those listed below.

Hydrocarbon waxes, such as microcrystalline wax, paraffin wax and Fischer Tropsch wax; oxides of hydrocarbon-base waxes, such as oxidized polyethylene wax and block copolymers thereof; waxes comprising mainly fatty acid esters, such as carnauba wax; and waxes obtained by partially or wholly deoxidizing fatty acid esters, such as deoxidized carnauba wax.

The further examples include those listed below: saturated straight-chain fatty acids, such as palmitic acid, stearic acid and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and melissyl alcohol; polyhydric alcohols such as sorbitol; esters of fatty acids such as palmitic acid, stearic acid, behenic acid and montanic acid with alcohols such as stearyl alcohol, aralkyl alcohol, behenyl alcohol, carnaubyl alcohol, ceryl alcohol and melissyl alcohol; fatty acid amides such as linoleamide, oleamide and lauramide; saturated fatty acid bisamides such as methylene bis stearamide, ethylene bis capramide, ethylene bis lauramide and hexamethylene bis stearamide; unsaturated tatty acid amides such as ethylene bis oleamide, hexamethylene bis oleamide, N,N′-dioleyl adipamide and N,N′-dioleyl sebacamide; aromatic bisamides such as m-xylene bis stearamide and N,N′-distearyl isophthalamide; aliphatic metal salts (commonly called metal soaps) such as calcium stearate, calcium laurate, zinc stearate and magnesium stearate; waxes obtained by grafting vinyl monomers such as styrene and acrylic acid onto aliphatic hydrocarbon waxes; partial esterification products of polyhydric alcohols and tatty acids, such as behenic acid monoglyceride; and methyl ester compounds having hydroxy groups obtained by hydrogenation of plant-based oils and fats.

The wax content is preferably 2.0 parts by mass or more and 30.0 parts by mass or less relative to 100 parts by mass of the binder resin.

### Charge Control Agent

The toner particle may contain a charge control agent as needed. Although any known charge control agent may be used as the charge control agent included in the toner, a metal compound of an aromatic carboxylic acid that is colorless, charges the toner at a high speed, and can stably hold a certain charge quantity can be particularly selected.

Examples of negative charge control agents include salicylic acid metal compounds, naphthoic acid metal compounds, dicarboxylic acid metal compounds, polymeric compounds having a sulfonic acid or a carboxylic acid in the side chain, polymeric compounds having a sulfonic acid salt or a sulfonic acid ester in the side chain, polymeric compounds having a carboxylic acid salt or a carboxylic acid ester in the side chain, and boron compounds, urea compounds, silicon compounds and calixarenes. The charge control agent may be added internally or externally to the toner particles.

The amount of the charge control agent added is preferably 0.2 parts by mass or more and 10 parts by mass or less relative to 100 parts by mass of the binder resin.

### Toner

The toner according to the present disclosure includes a toner particle and fine powder for toner fixed or attached to a surface of the toner particle.

### Fine Powder for Toner Content

The content of the fine powder for toner according to the present disclosure is preferably 0.1 parts by mass or more and 20.0 parts by mass or less relative to 100 parts by mass of the toner particle to reinforce the blocking layer and to reduce contamination of carriers and components. The content is more preferably 0.5 parts by mass or more and 15.0 parts by mass or less. The content is more preferably 1.0 parts by mass or more and 10.0 parts by mass or less.

If the content of the fine powder for toner is less than 0.1 parts by mass, the effect of the reinforced blocking layer is less likely to be demonstrated. If the content of the fine powder for toner exceeds 20.0 parts by mass, filming of the fine powder particle on the carrier, charging member, and photosensitive member may occur if the image output continues for a long time.

### Inorganic Fine Powder

In addition to the fine powder for toner described above, another inorganic fine powder may be further included in the toner as necessary. The additional inorganic fine powder may be added internally to the toner particle or mixed with the toner particle as an external additive. The inorganic fine powder may be silica when used as an external additive. The additional inorganic fine powder may be hydrophobically treated with a hydrophobic agent, such as a silane compound, silicone oil, and a mixture of these.

As the external additive to improve flowability, the inorganic fine powder having a specific surface area of 50 m²/g or more and 400 m²/g or less can be used. The above inorganic fine powder is preferably contained in 0.1 parts by mass or more and 10.0 parts by mass or less relative to 100 parts by mass of the toner particle. When the amount falls within the above range, the effect of charge stability can be readily obtained.

### Developing Agent

The toner can be used as a single component developing agent, but to further improve dot reproducibility and to provide long-term stability, the toner can be mixed with a magnetic carrier and used as a two-component developing agent.

A common and known magnetic carrier may be used, and examples thereof include surface oxidized iron powder, unoxidized iron powder, metal particles of iron, lithium, calcium, magnesium, nickel, copper, zinc, cobalt, manganese, chromium, rare earth, and the like, alloy particles and oxide particles of these, magnetic bodies, such as ferrite, and resin carriers having a dispersed magnetic body (so-called resin carriers) comprising a magnetic body and a binder resin carrying the magnetic body in a dispersed state.

When the toner is mixed with a magnetic carrier and used as a two-component developing agent, the carrier mixing ratio, as the toner concentration in the two-component developing agent, is preferably 2% by mass or more and 15% by mass or less, more preferably 4% by mass or more and 13% by mass or less, which normally can provide good results.

### Method for Producing Toner Particle and Toner

The method for producing the toner particle is not particularly limited, and a known method, such as suspension polymerization, emulsion aggregation, melt kneading, and dissolution suspension, may be used.

The fine powder for toner according to the present disclosure and, if necessary, the above-described other external additives are mixed with the produced toner particle to obtain toner. The toner particle can be mixed with the fine powder for toner according to the present disclosure and the other external additives by using mixers, such as a double cone mixer, a V mixer, a drum mixer, Super mixer, Henschel mixer, Nauta mixer, Mechano Hybrid (Nippon Coke and Engineering Co., Ltd.), and Nobilta (Hosokawa Micron Corporation).

Furthermore, to control the fixing ratio of the fine powder for toner on the toner particle, heat treatment can be performed after a toner particle mixture is produced by mixing the fine powder for toner with the toner particle. For example, the heat treatment apparatus illustrated in FIGURE may be used to perform heat treatment with hot air.

The heat treatment apparatus has a treatment chamber 6 for heat-treating the toner particle mixture, a toner particle mixture supplier for supplying the toner particle mixture to the treatment chamber 6, a hot air supplier 7 for supplying hot air for heat treating the toner particle mixture supplied from the toner particle mixture supplier, and a collecting portion 10 for discharging the heat-treated toner particle through a discharge port provided in the treatment chamber 6 to the outside of the treatment chamber 6 and collecting the discharged particle.

The heat treatment apparatus illustrated in FIGURE further has a regulator 9 as a cylindrical member, and the treatment chamber 6 has a cylindrical shape that covers the outer peripheral surface of the regulator 9. The hot air supplier 7 is disposed at one end side of the cylindrical treatment chamber 6 so that hot air flows in the cylindrical treatment chamber 6 while rotating. Furthermore, the toner particle mixture supplier is composed of a plurality of feed pipes 5 provided on the outer periphery of the treatment chamber 6.

Furthermore, the discharging port in the treatment chamber 6 is located at the outer periphery of the end portion of the treatment chamber 6 on the side opposite to the side where the hot air supplier 7 is provided and located on an extension line extending in the rotation direction of the toner particle mixture. The heat treatment using the heat treatment apparatus having the above configuration will be described below.

The toner particle mixture quantitatively supplied by a raw material quantitative supplier 1 is guided by the compressed gas adjusted by a compressed gas flow rate adjuster 2 to an introduction pipe 3 provided on the vertical line of the raw material qualitative supplier 1. The mixture that has passed through the introduction pipe is uniformly dispersed by a conical projection 4 located at the middle of the raw material quantitative supplier 1, and the mixture is guided to the feed pipes 5 spreading radially in eight directions and guided to the treatment chamber 6 where heat treatment is performed.

At this time, the flow of the mixture supplied to the treatment chamber 6 is regulated by a regulator 9 that is provided in the treatment chamber 6 to regulate the flow of the mixture. Thus, the mixture supplied to the treatment chamber is heat-treated while swirling in the treatment chamber 6 and then cooled.

The heat for heat-treating the supplied mixture is supplied from the hot air supplier 7, distributed by a distributing member 12, and introduced while being spirally swirled in the treatment chamber 6 by a swirling member 13 for swirling the hot air. The swirling member 13 that swirls hot air includes multiple blades, and the swirling of the hot air can be controlled by controlling the number or angle of the blades. The hot air is supplied through a hot air supplier discharge port 11.

The heat-treated toner particles are cooled by cold air supplied from a cold air supplier 8 (cold air suppliers 8-1, 8-2 and 8-3).

Next, the cooled toner particles are collected as toner by the collecting portion 10 located at the lower end of the treatment chamber. A blower (not illustrated) is disposed at the tip of the collecting portion, and the toner particles are suctioned and transported by the blower.

Furthermore, a powder particle supply port 14 is provided so that the swirling direction of the supplied mixture coincides with the swirling direction of the hot air, and the collecting portion 10 of the heat spheronizer is provided on the outer peripheral portion of the treatment chamber so as to maintain the swirling direction of the swirling powder particles. Furthermore, the cold air supplied by the cold air supplier 8 is supplied horizontally and tangentially from the outer peripheral portion of the apparatus to the inner peripheral surface of the treatment chamber.

The fine powder for toner according to the present disclosure preferably has a fixing ratio on the toner particle of 30% or more and 80% or less. When the fixing ratio is within the above range, the fine powder is supplied to the cleaning section in a suitable amount for the formation of the blocking layer.

### Image Forming Apparatus

An image forming apparatus employed to use the toner includes an electrophotographic photoreceptor having a support and a photosensitive layer formed on the support, an image forming unit for forming an electrostatic image on the electrophotographic photoreceptor, a developing unit for supplying toner to an electrostatic image formed on the electrophotographic photoreceptor, a transferring unit for transferring a toner image from the electrophotographic photoreceptor to a recording medium, and a fixing unit for fixing the transferred toner image on the recording medium by using heat and pressure.

### Methods for Measuring Physical Properties

The methods for measuring properties will be described below.

Separation of Fine Powder for Toner and Toner Particles from Toner

To 100 mL of ion-exchanged water, 200 g of Sucrose (available from Kishida Chemical Co., Ltd.) is added and dissolved while warmed in hot water, producing a sucrose concentrate. In a centrifuge tube, 31 g of the sucrose concentrate and 6 mL of Contaminon N (a 10% by mass aqueous solution of a pH 7 neutral detergent for cleaning precision measuring instruments, containing a nonionic surfactant, an anionic surfactant, and an organic builder, available from Wako Pure Chemical Industries) are placed to prepare a dispersion liquid. To the dispersion liquid, 1 g of toner is added, and clumps of the toner are broken up, for example, with a spatula.

The centrifuge tube is shaken with the shaker for 20 minutes under the condition of 350 reciprocations per minute. After shaking, the solution is transferred to a glass tube for a swing rotor (50 mL), and centrifugation is performed at 3,500 rpm for 30 minutes with a centrifuge. In the glass tube after centrifugation, the toner particle (including the fine powder for toner fixed to the surface of the toner particle) is present in the uppermost layer while the fine powder for toner separated from the toner particle is present on the aqueous solution side serving as the lower layer. The aqueous solution as the lower layer is collected and centrifuged to separate the sucrose from the fine powder for toner, and the fine powder for toner is collected. The centrifugation may be repeated as necessary for sufficient separation, followed by drying of the dispersion and collection of the fine powder for toner.

If other external additives are added, the fine powder for toner according to the present disclosure can be sorted out, for example, by using a centrifugation method. The physical properties described below are measured by using the fine powder for toner separated by the above method.

### Method for Measuring Number-Average Particle Diameter of Primary Particle of Fine Powder for Toner

The number-average particle diameter of the primary particle of the fine powder for toner can be measured by a centrifugal sedimentation method. Specifically, 0.01 g of dried fine powder is placed in a 25 mL glass vial, and 0.2 g of a 5% triton solution and 19.8 g of RO water are added thereto to produce a solution. Next, (the tip of) a probe of an ultrasonic homogenizer is immersed in the above solution and subjected to ultrasonic dispersion at an output of 20 W for 15 minutes to obtain the dispersion solution. Next, the number-average particle diameter of the primary particle is measured using this dispersion by using a centrifugal sedimentation particle size distribution measurement apparatus DC24000 available from CPS instruments, inc. The rotational speed of the disc is set to 18000 rpm, and the true density is set to 1.3 g/cm³. Before the measurement, the apparatus is calibrated using polyvinyl chloride particles having an average particle diameter of 0.476 m.

### Method for Obtaining Particle After Isolation of Silicone Oil

In 200 mL of hexane, 10 g of the fine powder for toner is dispersed, followed by ultrasonication at a frequency of 30 kHz, a power output capacity of 15 W, and an intensity of 100% for 5 minutes. After the ultrasonication, the dispersion is subjected to vacuum filtration, and the residue is collected and dried to obtain a particle after isolation of the silicone oil.

### Method for Measuring Volume-Average Diameter and Average Volume of Pores in Particles

The volume-average diameter and average volume of pores are measured by a gas adsorption method in which nitrogen gas is adsorbed on the sample surface using a pore distribution measuring device TriStar 3000 (Shimadzu Corporation). The measurement is performed according to the operation manual published by Shimadzu Corporation.

First, about 0.5 g of a sample is placed in a test tube, and vacuuming is performed at 100° C. for 24 hours. After the vacuuming is completed, the sample is precisely weighed, and thus the sample is obtained. From the obtained sample, the volume-average diameter and the average volume in the pore diameter range of 1.7 nm or more and 300.0 nm or less can be determined by the BJH method using the pore distribution measuring device described above. For the density value required for the measurement, the true density value measured by using a dry-process density meter AccuPyc 1330 (Shimadzu Corporation) is used.

### Analysis Method for Silicon Structure Using Solid-State ²⁹Si NMR

Solid-State ²⁹Si NMR analysis detects peaks in different shift regions depending on the structures of the functional group bonded to Si. The structure bound to Si can be identified by identifying each peak position by using a standard sample. The abundance ratio of each structure can be calculated from the obtained peak areas. The ratio of the peak area of each of Q unit structure, T unit structure, D unit structure, and M unit structure to the total peak area can be calculated.

The specific measurement condition for the Solid-State ²⁹Si-NMR is as follows.
Apparatus: JNM-ECX5002 (JEOL RESONANCE)
Temperature: room temperature
Measurement method: DDMAS method, ²⁹Si, 45°
Sample tube: zirconia, ø3.2 mm
Sample: powder filled into a test tube
Sample rotational frequency: 10 kHz
Relaxation delay: 180 s
Scan: 2000

After this measurement, the peaks of the multiple silane components having different substituents and linking groups are separated by curve fitting into formulas (1) to (4), and the respective peak areas are calculated.

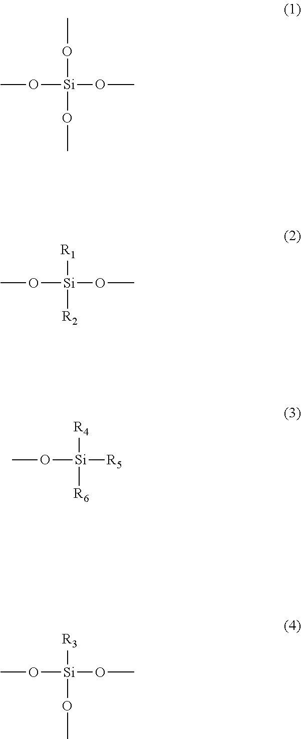

Formula (1): Q unit structure
Formula (2): D unit structure
Formula (3): M unit structure
Formula (4): T unit structure

In formulas (1) to (4), R₁ to R₆ each indicate an alkyl group having 1 to 6 carbon atoms. If it is necessary to know the structure in more detail, measurement results of ¹³C-NMR and ¹H-NMR may be identified together with the measurement result of ²⁹Si-NMR.

### Method for Measuring Compression and Agglomeration Degree of Fine Powder for Toner

The compression and agglomeration degree of the fine powder for toner is measured using Powder Rheometer (FT4, Freeman Technology). First, 10 g of the fine powder for toner is weighed in a special cylindrical split vessel and compressed at a specified pressure (60 kPa) using a compression test piston attached to the body. The sample compressed at 60 kPa is left for at least 1 hour in a dryer set at 100° C. until immediately before the measurement. The fine powder layer compressed at the split of the measurement vessel is leveled off such that the upper portion of the powder layer is removed. Next, a special needle-shaped jig is attached to the body and is moved vertically into the powder layer. The compression and agglomeration degree is determined by measuring the penetration force at this time.

### Method for Measuring Kinematic Viscosity of Silicone Oil

The kinematic viscosity of the isolated silicone oil is measured at 25° C. using an automatic micro kinematic viscometer (available from VISCOTECH CO., LTD.).

### Method for Measuring Number-Average Molecular Weight of Silicone Oil

The number-average molecular weight of the isolated silicone oil is measured by a usual method as follows. A sample is placed in tetrahydrofuran, and the measurement target and tetrahydrofuran are shaken to be mixed thoroughly. Next, a column is stabilized in a heat chamber at 40° C., tetrahydrofuran as a solvent is allowed to flow through the column at this temperature at a flow rate of 1 mL per minute, and 10 μL of the sample for GPC is injected to measure the number-average molecular weight of the measurement target. As the column, a column (trade name: TSKgel SuperHM-M) available from Tosoh Corporation is used.

When the number-average molecular weight is measured, the molecular weight distribution of the measurement target is calculated from the relationship between the logarithmic value and the number of counts in the calibration curve created using several types of monodisperse polystyrene standard samples, and a GPC chart is obtained. The standard polystyrene samples for calibration curves are monodisperse polystyrene (available from Aldrich) having the following 10 molecular weights: 3500, 12000, 40000, 75000, 98000, 120000, 240000, 500000, 800000, and 1800000. As the detector, an RI (refractive index) detector is used.

### Method for Measuring Fixing Ratio of Fine Powder for Toner on Toner Particle Washing Process

In a 30 mL glass vial, a sucrose solution in which 20.7 g of sucrose (available from KISHIDA CHEMICAL CO., LTD.) is dissolved in 10.3 g of ion-exchanged water and 6 mL of Contaminon N (a pH 7 neutral detergent for cleaning precision measuring instruments, containing a nonionic surfactant, an anionic surfactant, and an organic builder) are added and mixed thoroughly to produce a dispersion. As the glass vial, for example, VCV-30 having an outer diameter of 35 mm, and a height of 70 mm, available from Nichiden Rika Glass Co., Ltd. is available. To the dispersion, 1.0 g of toner is added and allowed to stand still until the toner settles naturally, forming a pre-treatment dispersion. The pre-treatment dispersion was shaken in a shaker (Model YS-8D, available from YAYOI CO., LTD.) at a shaking speed of 200 rpm for 5 minutes to remove weakly attached fine particles from the surface of the toner particle. The toner having particles remaining strongly attached to the toner is separated from the detached particle by using a centrifuge. The centrifugation was performed at 3700 rpm for 30 minutes. The toner having the remaining particle is collected by vacuum filtration and dried, and thus the toner after washing is obtained.

### Method for Measuring Fixing Ratio of Particle

The following is an example of a method for measuring the fixing ratio of a particle. First, the fine particles contained in the toner particles before the washing with water process are quantified. This is done using an X-ray fluorescence spectrometer Axios advanced (available from PANalytical) to measure the intensity of Si element in the toner particle. Next, the intensity of Si element in the toner particle after the washing process is measured in the same way. The fixing ratio (%) can be calculated by (intensity of Si element after washing process/intensity of Si element before washing process)×100.

### EXAMPLES

The present disclosure will be explained in detail by using the following examples. However, these examples do not limit the disclosure. In the following formulations, “parts” are all by mass unless otherwise noted.

### Example of Production of Fine Powder for Toner 1

### 1. Hydrolysis and Condensation Polymerization Process

(1) In a 500 mL beaker, 21.6 g of RO water, 135.0 g of methanol, 0.004 g of acetic acid as a catalyst, and 12.2 g of dimethyldimethoxysilane were placed and stirred at 45° C. for 5 minutes. (2) Into the above beaker, 2.0 g of 28% ammonia water, 15.0 g of tetraethoxysilane, and 5.0 g of an aqueous dispersion of colloidal silica for forming protruding particles (silica solid content: 40% by mass, particle diameter: 30 nm) were added and stirred at 30° C. for 3.0 hours to produce a raw material solution.

### 2. Process For Forming Particles

In a 1000 mL beaker, 120.0 g of RO water was placed, and the raw material solution produced in the process 1 above was added dropwise over 5 minutes while the RO water was stirred at 25° C. Then, the mixture was heated to 60° C. and stirred for 1.5 hours while the temperature was kept at 60° C. to produce a dispersion of fine powder.

### 3. Surface Treatment Process

To the dispersion of fine powder produced in the above “2. Process for Forming Particles”, 6.0 g of dimethyldimethoxysilane, 5.0 g of tetraethoxysilane, and 4.0 g of hexamethyldisilazane were added and stirred at 60° C. for 1.5 hours. The powder precipitated at the bottom of the solution after standing still for 5 minutes was collected by vacuum filtration and dried under reduced pressure at 120° C. for 24 hours, and thus fine powder for toner 1 was produced. Tables 1-1 and 1-2 show the physical properties of the produced fine powder for toner 1.

### Example of Production of Fine Powder for Toner 2

Fine powder for toner 2 was produced in the same way as the fine powder for toner 1 was produced, except that hexamethyldisilazane was not added, and 7.5 g of dimethyldimethoxysilane, 1.5 g of trimethoxymethylsilane, and 3.0 g of tetraethoxysilane were added in the surface treatment process. Tables 1-1 and 1-2 show the physical properties of the produced fine powder for toner 2.

### Example of Production of Fine Powder for Toner 3

Fine powder for toner 3 was produced in the same way as the fine powder for toner 1 was produced, except that the amount of dimethyldimethoxysilane was changed to 4.2 g in (1) of the hydrolysis and condensation polymerization process, the amount of tetraethoxysilane was changed to 23 g in (2), and the amount of dimethyldimethoxysilane was changed to 3.0 g, the amount of tetraethoxysilane was changed to 2.5 g, and the amount of hexamethyldisilazane was changed to 2.0 g in the surface treatment process. Tables 1-1 and 1-2 show the physical properties of the produced fine powder for toner 3.

### Example of Production of Fine Powder for Toner 4

Fine powder for toner 4 was produced in the same way as the fine powder for toner 3 was produced, except that the stirring time was changed to 1.0 hour in the surface treatment process. Tables 1-1 and 1-2 show the physical properties of the produced fine powder for toner 4.

### Example of Production of Fine Powder for Toner 5

Fine powder for toner 5 was produced in the same way as the fine powder for toner 1 was produced, except that an aqueous colloidal silica dispersion was not added in (2) of the hydrolysis and condensation polymerization process. Tables 1-1 and 1-2 show the physical properties of the produced fine powder for toner 5.

### Example of Production of Fine Powder for Toner 6

Fine powder for toner 6 was produced in the same way as the fine powder for toner 5 was produced, except that the stirring time was changed to 3.5 hours in (2) of the hydrolysis and condensation polymerization process. Tables 1-1 and 1-2 show the physical properties of the produced fine powder for toner 6.

### Example of Production of Fine Powder for Toner 7

Fine powder for toner 7 was produced in the same way as the fine powder for toner 5 was produced, except that the stirring time was changed to 2.5 hours in (2) of the hydrolysis and condensation polymerization process. Tables 1-1 and 1-2 show the physical properties of the produced fine powder for toner 7.

### Example of Production of Fine Powder for Toner 8

Fine powder for toner 8 was produced in the same way as the fine powder for toner 5 was produced, except that the stirring time was changed to 4.0 hours in (2) of the hydrolysis and condensation polymerization process. Tables 1-1 and 1-2 show the physical properties of the produced fine powder for toner 8.

### Example of Production of Fine Powder for Toner 9

Fine powder for toner 9 was produced in the same way as the fine powder for toner 5 was produced, except that the stirring time was changed to 2.0 hours in (2) of the hydrolysis and condensation polymerization process. Tables 1-1 and 1-2 show the physical properties of the produced fine powder for toner 9.

### Example of Production of Fine Powder for Toner 10

Fine powder for toner 10 was produced in the same way as the fine powder for toner 5 was produced, except that the amount of 28% ammonia water was changed to 2.5 g in (2) of the hydrolysis and condensation polymerization process. Tables 1-1 and 1-2 show the physical properties of the produced fine powder for toner 10.

### Example of Production of Fine Powder for Toner 11

Fine powder for toner 11 was produced in the same way as the fine powder for toner 5 was produced, except that the amount of 28% ammonia water was changed to 1.5 g in (2) of the hydrolysis and condensation polymerization process. Tables 1-1 and 1-2 show the physical properties of the produced fine powder for toner 11.

### Example of Production of Fine Powder for Toner 12

Fine powder for toner 12 was produced in the same way as the fine powder for toner 10 was produced, except that the temperature was changed to 50° C. in (1) of the hydrolysis and condensation polymerization process. Tables 1-1 and 1-2 show the physical properties of the produced fine powder for toner 12.

### Example of Production of Fine Powder for Toner 13

Fine powder for toner 13 was produced in the same way as the fine powder for toner 11 was produced, except that the temperature was changed to 40° C. in (1) of the hydrolysis and condensation polymerization process. Tables 1-1 and 1-2 show the physical properties of the produced fine powder for toner 13.

### Example of Production of Fine Powder for Toner 14

In a 2000 mL beaker, 124.0 g of ethanol, 24.0 g of RO water, and 10.0 g of 28% ammonia water were placed. The resulting solution was adjusted to 70° C., and 232.0 g of tetraethoxysilane and 84.0 g of 5.4% ammonia water were both added dropwise over 0.5 hours to the solution while stirring. After the dropwise addition was ended, the solution was kept stirred for another 0.5 hours to produce a dispersion of the silica particles through hydrolysis.

After adding 70.0 g of dimethyldimethoxysilane and 15.0 g of tetraethoxysilane at room temperature to the dispersion of the silica particles produced in the above process, the dispersion was heated to 50 to 60° C. and stirred for 1.5 hours. Then, the powder in the dispersion was collected by vacuum filtration and dried under reduced pressure at 120° C. for 24 hours, and thus fine powder for toner 14 was produced. Tables 1-1 and 1-2 show the physical properties of the produced fine powder for toner 14.

### Example of Production of Fine Powder for Toner 15

Fine powder for toner 15 was produced in the same way as the fine powder for toner 5 was produced, except that hexamethyldisilazane was not added, 13.5 g of dimethyldimethoxysilane and 2.0 g of tetraethoxysilane were added in the surface treatment process. Tables 1-1 and 1-2 show the physical properties of the produced fine powder for toner 15.

### Example of Production of Fine Powder for Toner 16

Fine powder for toner 16 was produced in the same way as the fine powder for toner 5 was produced, except that hexamethyldisilazane was not added, 8.0 g of dimethyldimethoxysilane, 7.0 g of tetraethoxysilane, and 0.5 g of 28% ammonia water were added in the surface treatment process. Tables 1-1 and 1-2 show the physical properties of the produced fine powder for toner 16.

### Example of Production of Fine Powder for Toner 17

Fine powder for toner 17 was produced in the same way as the fine powder for toner 5 was produced, except that the amount of dimethyldimethoxysilane was changed to 4.0 g, the amount of tetraethoxysilane was changed to 6.0 g, the amount of hexamethyldisilazane was changed to 5.0 g, and the reaction temperature was changed to 50° C., in the surface treatment process. Tables 1-1 and 1-2 show the physical properties of the produced fine powder for toner 17.

### Example of Production of Fine Powder for Toner 18

Fine powder for toner 18 was produced in the same way as the fine powder for toner 5 was produced, except that hexamethyldisilazane was not added, and 14.0 g of dimethyldimethoxysilane and 1.0 g of tetraethoxysilane were added in the surface treatment process. Tables 1-1 and 1-2 show the physical properties of the produced fine powder for toner 18.

Example of Production of Fine Powder for toner 19

In a 2000 mL beaker, 124.0 g of ethanol, 24.0 g of RO water, and 10.0 g of 28% ammonia water were placed. The resulting solution was adjusted to 70° C., and 232.0 g of tetraethoxysilane and 84.0 g of 5.4% ammonia water were both added dropwise over 0.5 hours to the solution while stirring. After the dropwise addition was ended, the solution was kept stirred for another 0.5 hours to produce a dispersion of the silica particles through hydrolysis. The dispersion was heated to 50 to 60° C. and stirred for 1.5 hours. Then, the powder in the dispersion was collected by vacuum filtration and dried under reduced pressure at 120° C. for 24 hours, and thus fine powder for toner 19 was produced. Tables 1-1 and 1-2 show the physical properties of the produced fine powder for toner 19.

### Example of Production of Fine Powder for Toner 20

Fine powder for toner 20 was produced in the same way as the fine powder for toner 1 was produced, except that hexamethyldisilazane was not added, and 3.0 g of dimethyl silicone oil having a kinematic viscosity of 100 mm²/s was added in the surface treatment process. Tables 1-1 and 1-2 show the physical properties of the produced fine powder for toner 20.

### Example of Production of Fine Powder for Toner 21

Fine powder 21 for toner was produced in the same way as the fine powder for toner 1, except that the amount of dimethyldimethoxysilane was changed to 18.0 g, the amount of tetraethoxysilane was changed to 15.0 g, the amount of hexamethyldisilazane was changed to 12.0 g, and the stirring time was changed to 2.0 hours in the surface treatment process. Tables 1-1 and 1-2 show the physical properties of the produced fine powder for toner 21.

### Example of Production of Fine Powder for Toner 22

Fine powder for toner 22 was produced in the same way as the fine powder for toner 14 was produced, except that tetraethoxysilane was not added, and 12.0 g of dimethyldimethoxysilane and 3.0 g of trimethoxymethylsilane were added to the dispersion of the silica particles. Tables 1-1 and 1-2 show the physical properties of the produced fine powder for toner 22.

TABLE 1-1

| | Isolated Silicone Oil | | | | | |
|---|---|---|---|---|---|---|
| | Composition Ratio | | | Number- | | |
| | | X2 + | | Average | Viscos- | Content |
| | X1 | X3 | | Molecular | ity | (% by |
| | (%) | (%) | X2/X1 | Weight | (mm²/s) | mass) |
| Fine Powder 1 | 26 | 74 | 1.9 | 800 | 900 | 3.0 |
| Fine Powder 2 | 15 | 75 | 5.0 | 820 | 850 | 3.0 |
| Fine Powder 3 | 26 | 74 | 1.9 | 800 | 900 | 1.0 |
| Fine Powder 4 | 26 | 74 | 1.9 | 800 | 900 | 0.5 |
| Fine Powder 5 | 26 | 74 | 1.9 | 800 | 900 | 3.0 |
| Fine Powder 6 | 26 | 74 | 1.9 | 800 | 900 | 3.0 |
| Fine Powder 7 | 26 | 74 | 1.9 | 800 | 900 | 3.0 |
| Fine Powder 8 | 26 | 74 | 1.9 | 800 | 900 | 3.0 |
| Fine Powder 9 | 26 | 74 | 1.9 | 800 | 900 | 3.0 |
| Fine Powder 10 | 26 | 74 | 1.9 | 800 | 900 | 3.0 |
| Fine Powder 11 | 26 | 74 | 1.9 | 800 | 900 | 3.0 |
| Fine Powder 12 | 26 | 74 | 1.9 | 800 | 900 | 3.0 |
| Fine Powder 13 | 26 | 74 | 1.9 | 800 | 900 | 3.0 |
| Fine Powder 14 | 17 | 83 | 4.8 | 800 | 900 | 3.0 |
| Fine Powder 15 | 5 | 95 | 19.0 | 2800 | 100 | 3.0 |
| Fine Powder 16 | 35 | 65 | 1.9 | 500 | 12000 | 2.0 |
| Fine Powder 17 | 35 | 65 | 0.9 | 150 | 50 | 3.0 |
| Fine Powder 18 | 3 | 97 | 32.0 | 5000 | 300 | 3.0 |
| Fine Powder 19 | — | — | — | — | — | 0 |
| Fine Powder 20 | 0 | 100 | — | 8000 | 100 | 3.0 |
| Fine Powder 21 | 24 | 76 | 2.0 | 800 | 900 | 20.0 |
| Fine Powder 22 | 0 | 85 | — | 5000 | 400 | 3.0 |

TABLE 1-2

| | Particle Obtained by Drying Residue Left After Filtration | | | | | | | |
|---|---|---|---|---|---|---|---|---|
| | | | | Pore | | | | |
| | | Number- | Compo- | Volume- | | | | Compression and |
| | | Average | sition | Average | Average | | | Agglomeration |
| | | Diameter | Ratio | Diameter | Volume | Protruding | (Y2/Y1)/ | Degree at 60 kPa |
| | Component | (nm) | Y2/Y1 | (nm) | (cm3/g) | Particle | (X2/X1) | (mJ) |
| Fine | Organosilicon | 110 | 0.9 | 14 | 0.45 | Yes | 0.5 | 120 |
| Powder 1 | Polymer | | | | | | | |
| Fine | Organosilicon | 110 | 0.9 | 12 | 0.42 | Yes | 0.2 | 120 |
| Powder 2 | Polymer | | | | | | | |
| Fine | Organosilicon | 110 | 0.25 | 13 | 0.43 | Yes | 0.1 | 100 |
| Powder 3 | Polymer | | | | | | | |
| Fine | Organosilicon | 115 | 0.25 | 13 | 0.43 | Yes | 0.1 | 90 |
| Powder 4 | Polymer | | | | | | | |
| Fine | Organosilicon | 100 | 1.2 | 14 | 0.45 | No | 0.6 | 87 |
| Powder 5 | Polymer | | | | | | | |
| Fine | Organosilicon | 80 | 1.2 | 14 | 0.45 | No | 0.6 | 120 |
| Powder 6 | Polymer | | | | | | | |
| Fine | Organosilicon | 150 | 1.2 | 14 | 0.45 | No | 0.6 | 85 |
| Powder 7 | Polymer | | | | | | | |
| Fine | Organosilicon | 60 | 1.2 | 14 | 0.45 | No | 0.6 | 130 |
| Powder 8 | Polymer | | | | | | | |
| Fine | Organosilicon | 170 | 1.2 | 14 | 0.45 | No | 0.6 | 80 |
| Powder 9 | Polymer | | | | | | | |
| Fine | Organosilicon | 100 | 1.2 | 5 | 0.30 | No | 0.6 | 110 |
| Powder 10 | Polymer | | | | | | | |
| Fine | Organosilicon | 100 | 1.2 | 20 | 1.00 | No | 0.6 | 85 |
| Powder 11 | Polymer | | | | | | | |
| Fine | Organosilicon | 100 | 1.2 | 4 | 0.25 | No | 0.6 | 120 |
| Powder 12 | Polymer | | | | | | | |
| Fine | Organosilicon | 100 | 1.2 | 25 | 1.10 | No | 0.6 | 82 |
| Powder 13 | Polymer | | | | | | | |
| Fine | Silica | 100 | 0 | 3 | 0.20 | No | 0 | 100 |
| Powder 14 | | | | | | | | |
| Fine | Organosilicon | 100 | 1.2 | 4 | 0.25 | No | 0.06 | 130 |
| Powder 15 | Polymer | | | | | | | |
| Fine | Organosilicon | 100 | 1.2 | 4 | 0.25 | No | 0.6 | 80 |
| Powder 16 | Polymer | | | | | | | |
| Fine | Organosilicon | 100 | 1.2 | 4 | 0.25 | No | 0.8 | 130 |
| Powder 17 | Polymer | | | | | | | |
| Fine | Organosilicon | 100 | 1.2 | 4 | 0.25 | No | 0.04 | 115 |
| Powder 18 | Polymer | | | | | | | |
| Fine | Silica | 100 | 0 | 3 | 0.20 | No | — | 70 |
| Powder 19 | | | | | | | | |
| Fine | Organosilicon | 110 | 0.9 | 14 | 0.45 | Yes | — | 110 |
| Powder 20 | Polymer | | | | | | | |
| Fine | Organosilicon | 110 | 0.9 | 14 | 0.45 | Yes | 0.5 | 140 |
| Powder 21 | Polymer | | | | | | | |
| Fine | Silica | 100 | 0 | 3 | 0.20 | No | — | 115 |
| Powder 22 | | | | | | | | |

### Example of Production of Polyester Resin A1

Polyoxypropylene (2.2)-2,2-bis(4-hydroxyphenyl) propane: 76.9 parts (0.167 parts by mole)
Terephthalic acid (TPA): 25.0 parts (0.145 parts by mole)
Adipic acid: 8.0 parts (0.054 parts by mole)
Titanium tetrabutoxide: 0.5 parts

The above materials were placed in a 4-liter glass four-neck flask, and a thermometer, a stirring rod, a condenser, and a nitrogen inlet tube were attached to the flask and placed in a mantle heater. Next, after replacing the inside of the flask with a nitrogen gas, the temperature was gradually increased while stirring, and the reaction was carried out for 4 hours while stirring at 200° C. (first reaction step). Then, 1.2 parts (0.006 parts by mole) of trimellitic anhydride (TMA) was added and reacted at 180° C. for 1 hour (second reaction step) to produce a polyester resin A1 as the binder resin component. The acid value of this polyester resin A1 was 5 mgKOH/g.

### Example of Production of Polyester Resin A2

Polyoxypropylene (2.2)-2,2-bis(4-hydroxyphenyl) propane: 71.3 parts (0.155 parts by mole)
terephthalic acid: 24.1 parts (0.145 parts by mole)
Titanium tetrabutoxide: 0.6 parts

The above materials were placed in a 4-liter glass four-neck flask, and a thermometer, a stirring rod, a condenser, and a nitrogen inlet tube were attached to the flask and placed in a mantle heater. Next, after replacing the inside of the flask with nitrogen gas, the temperature was gradually increased while stirring, and the reaction was carried out at 200° C. for 2 hours while stirring. Then, 5.8 parts (0.030 parts by mole) of trimellitic anhydride was added and reacted at 180° C. for 10 hours to produce a polyester resin A2. The acid value of this polyester resin A2 was 10 mgKOH/g.

### Example of Production of Toner Particle 1

Polyester resin A1: 70.0 parts
Polyester resin A2: 30.0 parts
Fischer-Tropsch wax (peak temperature of maximum endothermic peak: 78° C.): 5.0 parts
C.I. Pigment Blue 15: 3: 5.0 parts
3,5-di-t-butylsalicylic acid aluminum compound: 0.1 parts

The raw materials in the above formulation were mixed using a Henschel mixer (Model FM-75, available from Nippon Coke and Engineering Co., Ltd.) at a rotational speed of 20 s⁻¹ for 5 minutes and then kneaded using a twin-screw kneader (Model PCM-30, Ikegai Corp) set at a temperature of 125° C. and a rotational speed of 300 rpm. The resulting kneaded product was cooled and coarsely pulverized to a size of 1 mm or less using a hammer mill to produce a coarsely pulverized product. The resulting coarsely pulverized product was then finely pulverized using a mechanical pulverizer (T-250, available from Freund-Turbo Corporation). Furthermore, the finely pulverized product was classified using a rotating classifier (200TSP, available from Hosokawa Micron Corporation) to obtain a toner particle 1. The rotating classifier (200TSP, available from Hosokawa Micron Corporation) was operated at a classifying rotor rotational speed of 50.0 s⁻¹. The weight-average particle diameter (D4) of the obtained toner particle 1 was 5.9 m.

### Example of Production of Toner 1

Toner particle 1: 100 parts
Fine powder for toner 1: 6.0 parts

The above materials were mixed in a Henschel mixer Model FM-10C (MIIKE MACHINERY COMPANY, LIMITED) at a rotational speed of 30 s⁻¹ and a rotation time of 10 minutes to produce a toner particle mixture 1.

### Heat Treatment Process

The produced toner particle mixture 1 was heat treated by the surface treatment device illustrated in FIGURE to produce a toner 1. Table 2 shows the physical properties of the toner 1. The heat treatment was performed under the following operating conditions: a feed rate of 2 kg/hr, a hot air temperature of 150° C., a hot air flow rate of 6 m³/min, a cold air temperature of −5° C., a cold air flow rate of 2.5 m³/min, a blower air flow rate of 11 m³/min, and an injection air flow rate of 1 m³/min.

### Examples of Production of Toners 2 to 26

Toners 2 to 26 were produced in the same way as the toner 1 was produced, except that the kind of fine powder for toner, and whether or not the heat treatment process was performed, and the hot air temperature in the heat treatment process was changed to those listed in Table 2. Table 2 shows the fixing ratios of the fine powder for toner in the toners 2 to 26.

TABLE 2

| | | Fine Powder | | | | |
|---|---|---|---|---|---|---|
| | | | Content | | | |
| | | | Relative to | Heat Treatment | | |
| | | | 100 Parts | Process | | |
| | Toner | | of Toner | | Hot Air | Fixing |
| | Particle | | Particle | | Temperature | Ratio |
| | No. | No. | (parts) | Yes/No | (° C.) | (%) |
| Toner 1 | 1 | 1 | 6 | Yes | 120 | 60 |
| Toner 2 | 1 | 2 | 6 | Yes | 120 | 60 |
| Toner 3 | 1 | 1 | 6 | Yes | 150 | 58 |
| Toner 4 | 1 | 1 | 6 | No | — | 20 |
| Toner 5 | 1 | 1 | 20 | Yes | 120 | 60 |
| Toner 6 | 1 | 1 | 0.05 | Yes | 120 | 60 |
| Toner 7 | 1 | 3 | 6 | Yes | 120 | 60 |
| Toner 8 | 1 | 4 | 6 | Yes | 120 | 60 |
| Toner 9 | 1 | 5 | 6 | Yes | 120 | 60 |
| Toner 10 | 1 | 6 | 6 | Yes | 120 | 60 |
| Toner 11 | 1 | 7 | 6 | No | — | 40 |
| Toner 12 | 1 | 8 | 6 | Yes | 120 | 60 |
| Toner 13 | 1 | 9 | 6 | No | — | 30 |
| Toner 14 | 1 | 10 | 6 | Yes | 120 | 60 |
| Toner 15 | 1 | 11 | 6 | Yes | 120 | 60 |
| Toner 16 | 1 | 12 | 6 | Yes | 120 | 60 |
| Toner 17 | 1 | 13 | 6 | Yes | 120 | 60 |
| Toner 18 | 1 | 14 | 6 | Yes | 120 | 60 |
| Toner 19 | 1 | 15 | 6 | Yes | 120 | 60 |
| Toner 20 | 1 | 16 | 6 | Yes | 120 | 60 |
| Toner 21 | 1 | 17 | 6 | Yes | 120 | 60 |
| Toner 22 | 1 | 18 | 6 | Yes | 120 | 60 |
| Toner 23 | 1 | 19 | 6 | Yes | 120 | 60 |
| Toner 24 | 1 | 20 | 6 | Yes | 120 | 60 |
| Toner 25 | 1 | 21 | 6 | Yes | 120 | 60 |
| Toner 26 | 1 | 22 | 6 | Yes | 120 | 60 |

### Example of Production of Carrier 1

Magnetite 1 having a number-average particle diameter of 0.30 m (a magnetization strength of 65 Am²/kg under a magnetic field of 1000/4π (kA/m))
Magnetite 2 having a number-average particle diameter of 0.50 μm (a magnetization strength of 65 Am²/kg under a magnetic field of 1000/4π (kA/m))

To each of the above materials, 4.0 parts of silane compound (3-(2-aminoethylaminopropyl) trimethoxysilane) was added, and the fine particles were each mixed and stirred at a high speed at 100° C. or higher in a container.

### Phenol: 10% by Mass

Formaldehyde solution: 6% by mass (40% by mass of formaldehyde, 10% by mass of methanol, 50% by mass of water)
Magnetite 1 treated with the silane compound: 58% by mass
Magnetite 2 treated with the silane compound: 26% by mass

The above materials, 5 parts of 28% by mass aqueous ammonia solution, and 20 parts of water were placed in a flask, and the temperature was raised to 85° C. in 30 minutes while stirring and mixing and maintained, and the polymerization reaction was carried out for 3 hours to cure the phenolic resin to be produced. The cured phenolic resin was then cooled to 30° C., and after further addition of water, the supernatant liquid was removed, the precipitate was washed and dried with air. This was then dried under reduced pressure (5 mmHg or less) at 60° C. to produce a spherical carrier 1 of the magnetic dispersion type. The median diameter by volume (D50) was 34.2 m.

### Example of Production of Two-component Developing Agents 1 to 26

To 92.0 parts of the carrier 1, 8.0 parts of the toners 1 to 26 were each added and mixed by a V-type mixer (V-20, available from Seishin Enterprise Co., Ltd.) to produce two-component developing agents 1 to 26.

### Example 1

### Method for Evaluating Toner

As the image forming apparatus, a modified version of imagePRESS C810, which is a digital commercial printer available from CANON KABUSHIKI KAISHA was used, and the two-component developing agent 1 was placed in the developing unit for cyan. The printer was modified such that the fixing temperature, process speed, voltage direct current (VDC) of the developing agent carrier, charging voltage VD of the electrostatic latent image carrier, and laser power can be set as desired. For image output evaluation, FFh images (solid color images) with the desired image ratio were output, and VDC, VD, and laser power were adjusted to achieve the desired amount of toner on the FFh image on paper, and the evaluation described below was performed.

FFh is a value that represents 256 gradations as a hexadecimal number, where 00h represents the 1st gradation (white area) of 256 gradations and FFh is the 256th gradation (solid area) of 256 gradations.

The evaluation was performed by the following evaluation method, and Table 3 shows the results.

### Cleaning Performance Evaluation

Paper: CS-680 (68.0 g/m²) (distributed by Canon Marketing Japan Inc.)
Toner loading on paper: 0.35 mg/cm² (FFh image) (adjusted by a volt direct current (VDC) of the developing agent carrier, charging voltage VD of the electrostatic latent image carrier, and laser power)
Evaluation target image: ruled chart with 30% image ratio on the entire surface of the above A4 paper
Test environment: high temperature and high humidity environment (temperature 30° C./humidity 80% RH (hereafter, H/H))
Process speed: 450 mm/sec

The cleaning performance was evaluated after 100000 copies of the above evaluation target image were output. When a cleaning failure occurs, vertical streaks of dirt appear on the surface of the charging roller or on the paper. The visual evaluation made in this state was used as an index to evaluate the cleaning performance.

### Evaluation Criteria

A: No vertical streaks on paper, no stains on charging rollers
B: No vertical streaks on paper, with stains on charging rollers
C: One vertical streak on paper
D: Two vertical streaks on paper
E: Three vertical streaks on paper
F: Four vertical streaks on paper
G: Five vertical streaks on paper
H: Six or more vertical streaks on paper

### Developability Evaluation

Paper: GF-C081 (81.0 g/m²) (distributed by Canon Marketing Japan Inc.)
Toner loading on paper: 0.45 mg/cm² (adjusted by a volt direct current (VDC) of the developing agent carrier, charging voltage VD of the electrostatic latent image carrier, and laser power)
Evaluation target image: a repeated pattern of a solid area in the form of 2 mm wide strip and a white area in the form of 18 mm wide strip in a direction parallel to a sheet transport direction of the above A4 paper.
Test environment: normal temperature and low humidity environment (23° C., 5% RH), When 10000 copies of the patterned image were output, the output was suspended, and a halftone (80 h) image was output on the entire surface of the paper.

For all solid images, the image density was measured at 20 random locations using an X-Rite color reflection densitometer (500 series, available from X-Rite, Inc.), and evaluation was performed based on the difference between the maximum value and the minimum value of the image density (image density difference). If the silicone oil migrates from the fine powder for toner to a component and contaminates the component, a change in the density is likely to occur.

### Evaluation Criteria

A: Image density difference is less than 0.02
B: Image density difference is 0.02 or more and less than 0.04
C: Image density difference is 0.04 or more and less than 0.06
D: Image density difference is 0.06 or more and less than 0.08
E: Image density difference is 0.08 or more and less than 0.10
F: Image density difference is 0.10 or more and less than 0.12
G: Image density difference is 0.12 or more

### Examples 2 to 22 and Comparative Examples 1 to 4

Instead of the two-component developing agent 1, two-component developing agents 2 to 26 were used, and the evaluation was performed as the evaluation was performed in Example 1. Table 3 shows the evaluation results of Examples 2 to 22 and Comparative Examples 1 to 4.

TABLE 3

| | Two- | Cleaning Performance | | Developability | |
|---|---|---|---|---|---|
| | Component | Number of | | Image | |
| | Developing | Vertical | | Density | |
| | Agent No. | Streaks | Rank | Difference | Rank |
| Example 1 | 1 | 0 | A | 0.01 | A |
| Example 2 | 2 | 0 | A | 0.01 | A |
| Example 3 | 3 | 0 | B | 0.01 | A |
| Example 4 | 4 | 0 | B | 0.02 | B |
| Example 5 | 5 | 0 | B | 0.03 | B |
| Example 6 | 6 | 1 | C | 0.03 | B |
| Example 7 | 7 | 1 | C | 0.01 | A |
| Example 8 | 8 | 2 | D | 0.01 | A |
| Example 9 | 9 | 2 | D | 0.01 | A |
| Example 10 | 10 | 0 | A | 0.05 | C |
| Example 11 | 11 | 3 | E | 0.03 | B |
| Example 12 | 12 | 0 | A | 0.07 | D |
| Example 13 | 13 | 3 | E | 0.04 | C |
| Example 14 | 14 | 1 | C | 0.05 | C |
| Example 15 | 15 | 3 | E | 0.01 | A |
| Example 16 | 16 | 1 | C | 0.07 | D |
| Example 17 | 17 | 4 | F | 0.01 | A |
| Example 18 | 18 | 3 | E | 0.03 | B |
| Example 19 | 19 | 2 | D | 0.08 | E |
| Example 20 | 20 | 5 | G | 0.03 | B |
| Example 21 | 21 | 2 | D | 0.10 | F |
| Example 22 | 22 | 2 | D | 0.09 | E |
| Comparative | 23 | 6 | H | 0.01 | A |
| Example 1 | | | | | |
| Comparative | 24 | 2 | D | 0.14 | G |
| Example 2 | | | | | |
| Comparative | 25 | 0 | A | 0.16 | G |
| Example 3 | | | | | |
| Comparative | 26 | 2 | D | 0.12 | G |
| Example 4 | | | | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-073893, filed Apr. 30, 2024 and No. 2025-044309, filed Mar. 19, 2025, which are hereby incorporated by reference herein in their entirety.

What is claimed is:

1. Fine powder for toner comprising:
a silicone oil, wherein
the silicone oil isolated by an isolating method satisfies (i) and (ii) based on a total number of silicon atoms:
(i) a percentage by number X1(%) of a silicon atom having a structure represented by formula (1) is 1% or more and 40% or less; and
(ii) a sum of a percentage by number X2(%) of a silicon atom having a structure represented by formula (2) and a percentage by number X3(%) of a silicon atom having a structure represented by formula (3) is 60% or more and 99% or less,
the isolated silicone oil is contained in an amount of 0.1% by mass or more and 10.0% by mass or less based on a mass of the fine powder,
the isolating method includes:
a) dispersing 10 g of the fine powder in 200 mL of hexane, followed by ultrasonication at a frequency of 30 kHz, a power output capacity of 15 W, and an intensity of 100% for 5 minutes;
b) performing vacuum filtration on a dispersion obtained by the ultrasonication; and
c) collecting filtrate and distilling off the hexane to isolate the silicone oil, and 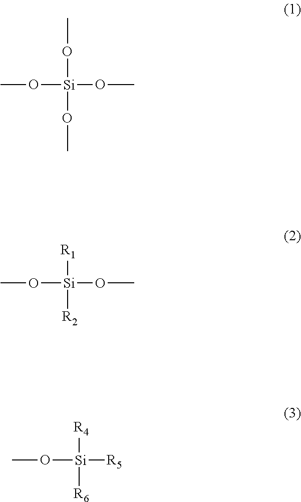
where R₁, R₂, and R₄ to R₆ each independently represent an alkyl group having 1 or more and 6 or less carbon atoms.

2. The fine powder for toner according to claim 1, wherein the percentage by number X1(%) and the percentage by number X2(%) of the isolated silicone oil satisfy:
$$1. \leq X 2 / X 1 \leq 20.0 .$$

3. The fine powder for toner according to claim 1, wherein the isolated silicone oil has a number-average molecular weight of 300 or more and 3000 or less.

4. The fine powder for toner according to claim 1, wherein the isolated silicone oil has a kinematic viscosity of 100 mm²/s or more and 10000 mm²/s or less.

5. The fine powder for toner according to claim 1, wherein a particle obtained by drying a residue left after the filtration in the isolating method is an organosilicon polymer particle having one of structures represented by formulas (1), (2), (3), and (4), 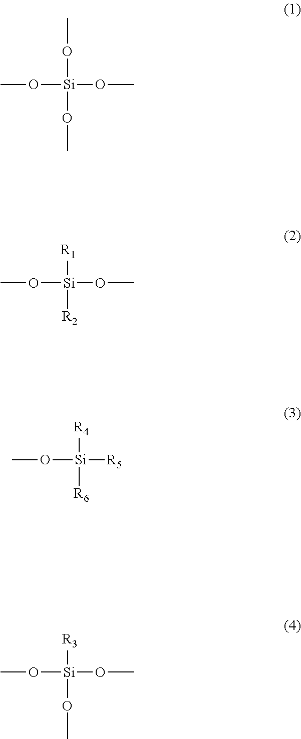
where R₁ to R₆ each independently represent an alkyl group having 1 or more and 6 or less carbon atoms.

6. The fine powder for toner according to claim 5, wherein the particle obtained by drying the residue satisfies:
$$0 \leq ( Y 2 / Y 1 ) / ( X 2 / X 1 ) \leq 3.$$
where Y1(%) is a percentage by number of a silicon atom having the structure represented by formula (1), and Y2(%) is a percentage by number of a silicon atom having the structure represented by formula (2), based on a total number of silicon atoms in the particle obtained by drying the residue.

7. The fine powder for toner according to claim 1, wherein a particle obtained by drying a residue left after the filtration in the isolating method has pores, the pores have a volume-average diameter of 5 nm or more and 20 nm or less, and the pores have an average volume of 0.3 cm³/g or more and 1.0 cm³/g or less.

8. The fine powder for toner according to claim 1, having a number-average diameter of 80 nm or more and 150 nm or less.

9. The fine powder for toner according to claim 1, wherein a particle obtained by drying a residue left after the filtration in the isolating method is a composite fine particle having a base particle and a protruding particle partially embedded in a surface of the base particle, and
the base particle contains an organosilicon polymer having one of structures represented by formulas (1), (2), (3), and (4): 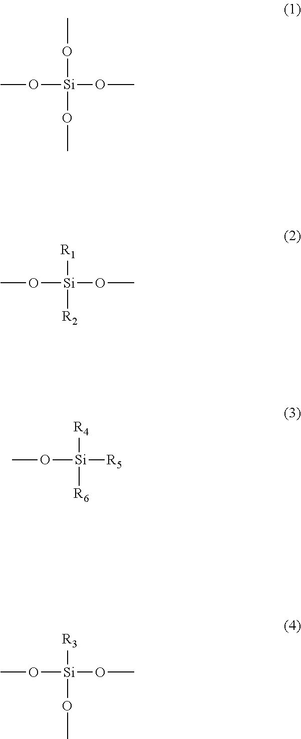
where R₁ to R₆ each independently represent an alkyl group having 1 or more and 6 or less carbon atoms.

10. The fine powder for toner according to claim 1, having a compression and agglomeration degree at 60 kPa of 100 mJ or more.

11. Toner comprising:
a toner particle; and
fine powder fixed or attached to a surface of the toner particle, wherein
the fine powder comprises a silicone oil,
the silicone oil isolated by an isolating method satisfies the following (i) and (ii) based on a total number of silicon atoms:
(i) a percentage by number X1(%) of a silicon atom having a structure represented by formula (1) is 1% or more and 40% or less; and
(ii) a sum of a percentage by number X2(%) of a silicon atom having a structure represented by formula (2) and a percentage by number X3(%) of a silicon atom having a structure represented by formula (3) is 60% or more and 99% or less,
the isolated silicone oil is contained in an amount of 0.1% by mass or more and 10.0% by mass or less based on a mass of the fine powder for toner,
the isolating method includes:
a) dispersing 10 g of the fine powder in 200 mL of hexane, followed by ultrasonication at a frequency of 30 kHz, a power output capacity of 15 W, and an intensity of 100% for 5 minutes;
b) performing vacuum filtration on a dispersion obtained by the ultrasonication; and
c) collecting filtrate and distilling off the hexane to isolate the silicone oil, and 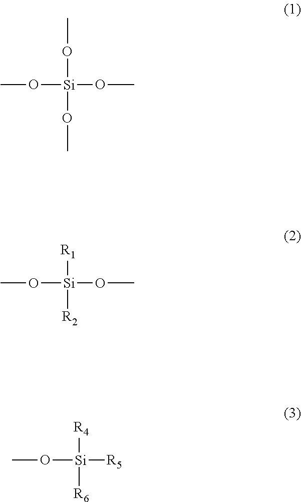
where R₁, R₂, and R₄ to R₆ each independently represent an alkyl group having 1 or more and 6 or less carbon atoms.

12. The toner according to claim 11, wherein the fine powder is contained in an amount of 0.1 parts by mass or more and 20.0 parts by mass or less relative to 100 parts by mass of the toner particle.

13. The toner according to claim 11, wherein a fixing ratio of the fine powder on the toner particle is 30% or more and 80% or less.
